(19) United States
(12) Patent Application Publication
(10) Pub. No.: US 2016/0219883 A1
(43) Pub. Date: Aug. 4, 2016

(54) MULTI-PART KIT SYSTEM FOR THE PREPARATION OF A DISINFECTANT

(71) Applicant: THE CHEMOURS COMPANY FC, LLC, WILMINGTON, DE (US)

(72) Inventors: MARK WALLACE SQUIRE, NEWMARKET (GB); CATHERINE MARY CHALONER, SUFFOLK (GB); SHARON ELIZABETH HICKS, SUFFOLK (GB); KELLY ANN BOARD, SUFFOLK (GB); MARTIAL JEAN-JACQUES PABON, PREVESSIN (FR)

(21) Appl. No.: 15/096,318

(22) Filed: Apr. 12, 2016

Related U.S. Application Data
(63) Continuation-in-part of application No. 13/585,953, filed on Aug. 15, 2012.
(60) Provisional application No. 61/528,465, filed on Aug. 29, 2011.

(51) Int. Cl. A01N 59/02; A01N 33/12; A01N 41/04

(52) U.S. Cl. CPC A01N 59/02; A01N 41/04; A01N 33/12

(57) ABSTRACT

A multi-part kit system comprising (i) a solid part A which comprises 10 to 80 wt. % of peroxy compound selected from the group consisting of KHSO₅, K₂S₂O₈, Na₂S₂O₈, magnesium monoperoxyphthalate hexahydrate, sodium percarbonate and sodium perborate, 0.1 to 10 wt. % of LiCl, NaCl and/or KCl and 1 to 20 wt. % of H₂N(CH₂)ₙSO₃H with n=0, 1, 2 or 3, and (ii) a liquid part B in the form of an aqueous solution which comprises 0 to 20 wt. % of nonionic surfactant, 3.6 to 20 wt. % of amphoteric surfactant and 0.5 to 20 wt. % of at least one compound comprising substituted ammonium selected from the group consisting of dihydrocarbyl dimethylammonium chlorides or bromides, didecyl methyl-poly(oxyethyl) ammonium propionate, chlorhexidine gluconate, cetylpyridinium chloride or bromide, and polyhexamethylene biguanide hydrochloride, wherein at least one of the two hydrocarbyl residues comprises 8 to 18 carbon atoms.

### FIELD OF THE INVENTION

The invention relates to a multi-part kit system for the preparation of a disinfectant and the use thereof in a process for the preparation of a disinfectant.

### BACKGROUND OF THE INVENTION

WO 2008/043638 A1 discloses aqueous liquid cleaning compositions comprising a bleaching composition and an activator composition. The bleaching composition comprises KHSO₅, an ammonium based thickening surfactant system and an inorganic acid, whereas the activator composition comprises a water-soluble inorganic halide like NaCl and a thickening polymer. The ammonium based thickening surfactant system comprises a tertiary amine surfactant in combination with amine oxide surfactant and/or quaternary ammonium salt surfactant.

There is still a need in the market for other effective, shelf stable disinfectant systems, particularly multi-part kit systems which resist unwanted precipitate formation in use.

### SUMMARY OF THE INVENTION

The present invention provides an easy-to-use multi-part kit system for the preparation of an efficient disinfectant comprising a combination of a peroxy biocide and a co-biocide of the substituted ammonium type, a process for the preparation of the disinfectant making use of the multi-part kit system, and the disinfectant itself. The disinfectant itself made by mixing the parts of the multi-part kit system and water is distinguished by a considerable stability in terms of only slow loss of peroxidic oxygen (active oxygen) and a low or even negligible tendency to develop unwanted precipitate.

Accordingly, the present invention provides a multi-part kit system comprising (i) a solid part A which comprises 10 to 80 wt. % (weight percent) of at least one peroxy compound selected from the group consisting of KHSO₅, K₂S₂O₈, Na₂S₂O₈, magnesium monoperoxyphthalate hexahydrate, sodium percarbonate and sodium perborate, 0.1 to 10 wt. % of at least one MCI compound and 1 to 20 wt. % of at least one H₂N(CH₂)ₙSO₃H compound with n=0, 1, 2 or 3, and (ii) a liquid part B in the form of an aqueous solution which comprises 0 to 20 wt. % of nonionic surfactant, 3.6 to 20 wt. % of amphoteric surfactant and 0.5 to 20 wt. % of at least one compound comprising substituted ammonium selected from the group consisting of dihydrocarbyl dimethylammonium halides, didecyl methyl-poly(oxyethyl) ammonium propionate, chlorhexidine gluconate, cetylpyridinium halide and polyhexamethylene biguanide hydrochloride, wherein M is selected from the group consisting of lithium, sodium and potassium, wherein at least one of the two hydrocarbyl residues, each of which can vary independently, comprises 8 to 18 carbon atoms, and wherein halide means chloride or bromide.

In a preferred embodiment, the present invention provides a two-part kit system consisting of said solid part A and said liquid part B.

### DETAILED DESCRIPTION OF THE INVENTION

The term “multi-part kit system” or “two-part kit system” is used in the description and the claims. It means a kit system comprised of several or two parts which are stored separate from each other until being used; i.e., until the parts are mixed to form the disinfectant.

In referring to the components of a particular part of a multi-part kit, unless otherwise indicated, the weight % of the component is based on the total weight of that particular part. For example, the wt. % of the components of Part A is based on the total weight of Part A and so forth for the other parts.

The term “solid part A” is used in the description and the claims. It refers to the fact that part A of the multi-part kit system of the present invention is a solid. The components forming part A may comprise components which are not solid but may be pasty or liquid, for example; however, it is preferred that all components forming part A are solids. The solid part A may be in the form of a flowable powder or it may take the form of pellets or tablets, for example. The solid nature of part A allows for its easy dosing when mixing with the liquid part B and water in order to prepare the disinfectant which is an aqueous solution.

The solid part A of the multi-part kit system of the present invention comprises 10 to 80 wt. %, preferably 18 to 43 wt. %, and particularly 26 to 41 wt. % of at least one peroxy compound selected from the group consisting of KHSO₅, K₂S₂O₈, Na₂S₂O₈, magnesium monoperoxyphthalate hexahydrate, sodium percarbonate and sodium perborate.

KHSO₅ is not commercially available as a pure compound but in the form of a triple salt with the formula 2KHSO₅.KHSO₄.K₂SO₄, for example, from DuPont as DuPont™ Oxone® monopersulfate compound; therefore, in case the solid part A contains KHSO₅,the latter is typically contained as said triple salt and, as a consequence, is accompanied by the respective amount of KHSO₄ and K₂SO₄.

In a preferred embodiment, the solid part A comprises KHSO₅ and preferably no other peroxy compound. The KHSO₅ may then be contained in the solid part A in a proportion of 10 to 80 wt. %, preferably of 18 to 43 wt. %, and particularly of 26 to 41 wt. %, or, more precisely, the KHSO₅ may then be contained in the solid part A as 2KHSO₅.KHSO₄.K₂SO₄ in a proportion of 20 to 98.9 wt. %, preferably of 36 to 87 wt. %, and particularly of 53 to 82 wt. %.

The solid part A of the multi-part kit system of the present invention comprises 0.1 to 10 wt. %, preferably 0.2 to 2.6 wt. % and particularly 0.4 to 1.7 wt. % of at least one MCI compound, wherein M is selected from the group consisting of lithium, sodium and potassium. In a preferred embodiment, the solid part A comprises NaCl and preferably no other MCI compound.

The solid part A of the multi-part kit system of the present invention comprises 1 to 20 wt. %, preferably 3 to 20 wt. % and particularly 5 to 18 wt. % of at least one H₂N(CH₂)ₙSO₃H compound with n being 0, 1, 2 or 3, and in particular 2. In a preferred embodiment, the solid part A comprises H₂N(CH₂)₂SO₃H and preferably no other H₂N(CH₂)ₙSO₃H compound.

In addition to the at least one peroxy compound, the at least one MCI compound and the at least one H₂N(CH₂)ₙSO₃H compound, the solid part A may comprise one or more further additives in a total proportion of, for example, up to 80 wt. %, preferably in the range of 5 to 50 wt. % and particularly in the range of 10 to 33 wt. %. Examples of such further additives that may be contained in the solid part A include solid water-soluble inorganic fillers, for example, sodium sulphate, sodium carbonate, sodium bicarbonate, sodium acetate, potassium sulphate, potassium carbonate, potassium bicarbonate; solid pH-modifiers, for example, malic acid, citric acid, succinic acid, adipic acid, maleic acid, tartaric acid; dyes; and peroxide decomposition stabilizers such as transition metal sequestering (complexing, chelating) agents. Examples of transition metal sequestering agents comprise compounds having nitrogen and/or oxygen donors as ligands, such as dimethylglyoxime, triazacycloalkane compounds, especially 1,4,7-triazacyclononanes (TACNs) or dipyridylamine (DPA); carboxylic acid derivatives such as ethylenediamine-N,N,N′,N′-tetraacetic acid (EDTA) and its alkali salts, diethylenetriam ine-N,N,N′,N′,N″-pentaacetic acid (DTPA) and its alkali salts, nitrilo-2,2′,2″-triacetic acid (NTA) and its alkali salts; phosphonic acid derivatives such as 1,2-diaminocyclohexyl tetra(methylene phosphonic acid) and its alkali salts, diethylene triamine penta(methylene phosphonic acid) and its alkali salts, ethylene diamine tetra(methylene phosphonic acid) and its alkali salts, polyphosphate compounds and their alkali salts.

In a preferred embodiment, the solid part A of the two-part or multi part kit system of the present invention has a composition as follows:

36 to 87 wt. % of the triple salt 2KHSO₅.KHSO₄.K₂SO₄;

0.2 to 2.6 wt. % of NaCl;

3 to 20 wt. % of H₂N(CH₂)₂SO₃H; and

5 to 50 wt. % of one or more further additives selected from the group consisting of solid water-soluble inorganic fillers, solid pH-modifiers, dyes and peroxide decomposition stabilizers, wherein the sum of the wt. % totals 100 wt. %.

In a particular embodiment, the solid part A of the two-part or multi part kit system of the present invention has a composition as follows:

53 to 82 wt. % of the triple salt 2KHSO₅.KHSO₄.K₂SO₄;

0.4 to 1.7 wt. % of NaCl;

5 to 18 wt. % of H₂N(CH₂)₂SO₃H; and

10 to 33 wt. % of one or more further additives selected from the group consisting of solid water-soluble inorganic fillers, solid pH-modifiers, dyes and peroxide decomposition stabilizers, wherein the sum of the wt. % totals 100 wt. %.

The solid part A may be prepared by mixing, in particular powder blending, all the required constituents. Apart from mixing operations the preparation of solid part A may also include grinding and/or compacting operations such as, for example, pelletizing and/or tableting operations.

The liquid part B of the multi-part kit system of the present invention is an aqueous solution comprising 0 to 20 wt. % of nonionic surfactant, 3.6 to 20 wt. % of amphoteric surfactant and 0.5 to 20 wt. % of at least one compound comprising substituted ammonium selected from the group consisting of dihydrocarbyl dimethylammonium halides with at least one of the two hydrocarbyl residues, each of which can vary independently, having 8 to 18 carbon atoms, didecyl methyl-poly(oxyethyl) ammonium propionate, chlorhexidine gluconate, cetylpyridinium halide and polyhexamethylene biguanide hydrochloride, wherein halide means chloride or bromide.

The phrase “compound comprising substituted ammonium selected from the group consisting of dihydrocarbyl dimethylammonium halides with at least one of the two hydrocarbyl residues having 8 to 18 carbon atoms, didecyl methyl-poly(oxyethyl) ammonium propionate, chlorhexidine gluconate, cetylpyridinium halide and polyhexamethylene biguanide hydrochloride, wherein halide means chloride or bromide” is used in the present description and the claims. For brevity, it is also herein named “compound comprising substituted ammonium”.

The liquid part B of the multi-part kit system of the present invention comprises 25 to 95.9 wt. %, preferably 57 to 84 wt. %, and particularly 62 to 80 wt. % of water.

The liquid part B of the multi-part kit system of the present invention comprises 0 to 20 wt. %, preferably 1 to 14 wt. %, and particularly 2 to 10 wt. % of one or more nonionic surfactants. Nonionic surfactants are in particular ones comprising at least one polyoxyethylene and/or polyoxypropylene and/or polyoxyethylene/oxypropylene moiety. Preferred examples of such nonionic surfactants include polyethoxylated alcohols, in particular, polyethoxylated fatty alcohols. Examples of commercially available nonionic surfactants that can be used in part B include Genapol T-250 from Clariant, Rovol T500 from White Sea and Baltic Company Ltd, and Lutensol® AT 50 from BASF.

The commercially available nonionic surfactants may not be pure active substance and they may contain water and/or organic solvents and/or other auxiliary substances; however, the corresponding wt. % specifications made in the description and the claims refer to active substance; i.e., nonionic surfactant as such.

The liquid part B of the multi-part kit system of the present invention comprises 3.6 to 20 wt. %, preferably 6 to 20 wt. %, and particularly 8 to 20 wt. % of one or more amphoteric surfactants. Examples of amphoteric surfactants include betaine-, glycinate-, aminopropionate-, amphoacetate- and imidazoline-based amphoterics, in particular, betaine-based amphoterics. Examples of commercially available amphoteric surfactants that can be used in part B include Ampholak® YCE and Ampholak® XCE both from Akzo Nobel, Amphoteric® SC from Tomah, Mackam® 2CY from McIntyre Group and Mirataine® D40 from Rhone-Poulenc.

The commercially available amphoteric surfactants may not be pure active substance and they may contain water and/or organic solvents and/or other auxiliary substances; however, the corresponding wt. % specifications made in the description and the claims refer to active substance; i.e., amphoteric surfactant as such.

The liquid part B of the multi-part kit system of the present invention comprises 0.5 to 20 wt. %, preferably 2 to 18 wt. %, and particularly 4 to 14 wt. % of at least one compound comprising substituted ammonium as a co-biocide. The at least one compound comprising substituted ammonium is selected from the group consisting of dihydrocarbyl dimethylammonium halides with at least one of the two hydrocarbyl residues having 8 to 18 carbon atoms, didecyl methyl-poly(oxyethyl) ammonium propionate, chlorhexidine gluconate, cetylpyridinium halide and polyhexamethylene biguanide hydrochloride, wherein halide means chloride or bromide. To avoid misunderstandings, the term “dihydrocarbyl dimethylammonium halide with at least one of the two hydrocarbyl residues having 8 to 18 carbon atoms” used herein shall not be understood to exclude compounds of the C8- to C18-hydrocarbyl trimethylammonium halide type; rather, said term shall be understood to include C8- to C18-hydrocarbyl trimethylammonium halides. Examples of dihydrocarbyl dimethylammonium halides which can be used include didecyldimethylammonium chloride and di(hydrogenated tallow)dimethyl ammonium chloride. Benzalkonium chlorides of the formula C₆H₅CH₂(CH₃)₂(CₙH₂ₙ₊₁)N⁺Cl⁻ with n=8, 10, 12, 14, 16 or 18 are preferred examples of useful dihydrocarbyl dimethylammonium halides.

Examples of commercially available compounds comprising substituted ammonium that can be used in the liquid part B include Barquat® CB50/80, Barquat® CT35, Barquat® DM50/80, Barquat® LB50, Barquat® MB50/80, Barquat® MS100, Barquat® BB50 and Bardac® 22, Bardac® 2240, Bardac® 2270, Bardac® 2270E from Lonza; Arquad® 16-29, Arquad® 16-50, Arquad® 2.10-80, Arquad® 2HT-75, Arquad® 2HT-75E, Arquad® 2HT-75PG, Arquad® MCB-50, Arquad® MCB-80, Arquad® MCB-80(S) from Akzo Nobel Surfactants; Ammonyx® CETAC, BTC® series, Stepanquat® series from Stepan; and Empigen® BAC series from Huntsman. The commercially available compounds comprising substituted ammonium may not be pure active substance and they may contain water and/or organic solvents and/or other auxiliary substances; however, the corresponding wt. % specifications made in the description and the claims refer to active substance; i.e., compound comprising substituted ammonium as such.

In a preferred embodiment, the liquid part B comprises one or more dihydrocarbyl dimethylammonium chlorides with at least one of the two hydrocarbyl residues having 8 to 18 carbon atoms and preferably none of the following compounds: didecyl methyl-poly(oxyethyl) ammonium propionate, chlorhexidine gluconate, cetylpyridinium chloride, cetylpyridinium bromide and polyhexamethylene biguanide hydrochloride. In a particular embodiment of said preferred embodiment, the one or more dihydrocarbyl dimethylammonium chlorides with at least one of the two hydrocarbyl residues having 8 to 18 carbon atoms are selected from the group consisting of didecyldimethylammonium chloride and benzalkonium chlorides of the formula C₆H₅CH₂(CH₃)₂(CₙH₂ₙ₊₁)N⁺Cl⁻ with n=8, 10, 12, 14, 16 or 18.

In addition to water, nonionic surfactant, amphoteric surfactant and the at least one compound comprising substituted ammonium the liquid part B may comprise one or more further additives in a total proportion of, for example, up to 10 wt. %, preferably in the range of 1 to 6 wt. %. Examples of further additives that may be contained in the liquid part B include MCI compounds, hard water sequestrants, corrosion inhibitors, water-soluble solvents like alcohols or glycols, and, in particular, peroxide decomposition stabilizers.

In a preferred embodiment, the liquid part B of the two-part or multi part kit system of the present invention has a composition as follows:

57 to 84 wt. % of water;

1 to 14 wt. % of nonionic surfactant;

6 to 20 wt. % of amphoteric surfactant;

2 to 18 wt. % of at least one compound selected from the group consisting of didecyldimethylammonium chloride and benzalkonium chlorides of the formula C₆H₅CH₂(CH₃)₂(CₙH₂ₙ₊₁)N⁺Cl⁻ with n=8, 10, 12, 14, 16 or 18; and

1 to 6 wt. % of one or more further additives selected from the group consisting of MCI compounds, hard water sequestrants, corrosion inhibitors, water-soluble solvents, and peroxide decomposition stabilizers, wherein the sum of the wt. % totals 100 wt. %.

In a particular embodiment, the liquid part B of the two-part or multi part kit system of the present invention has a composition as follows:

62 to 80 wt. % of water;

2 to 10 wt. % of nonionic surfactant;

8 to 20 wt. % of amphoteric surfactant;

4 to 14 wt. % of at least one compound selected from the group consisting of didecyldimethylammonium chloride and benzalkonium chlorides of the formula C₆H₅CH₂(CH₃)₂(CₙH₂ₙ₊₁)N⁺Cl⁻ with n=8, 10, 12, 14, 16 or 18; and

1 to 6 wt. % of one or more further additives selected from the group consisting of MCI compounds, hard water sequestrants, corrosion inhibitors, water-soluble solvents, and peroxide decomposition stabilizers, wherein the sum of the wt. % totals 100 wt. %.

It is preferred that none of the following substances is contained in any part of the multi-part kit system of the present invention: inorganic acids other than H₂NSO₃H, tertiary amines, amine oxides, thickeners, compounds comprising metals other than alkali metals and alkaline earth metals.

Preferred multi-part kit systems of the present invention comprise (i) a solid part A composed according to its preferred embodiment and (ii) a liquid part B also composed according to its preferred embodiment.

Preferred two-part kit systems of the present invention consist of (i) a solid part A composed according to its preferred embodiment and (ii) a liquid part B also composed according to its preferred embodiment.

Particularly preferred multi-part kit systems of the present invention comprise (i) a solid part A composed according to its particular embodiment and (ii) a liquid part B composed according to its particular embodiment.

Particularly preferred two-part kit systems of the present invention consist of (i) a solid part A composed according to its particular embodiment and (ii) a liquid part B composed according to its particular embodiment.

It is preferred that parts A and B of the two- or multi-part kit system of the present invention are such, i.e. composition and packaging sizes of parts A and B are preferably such, that upon mixing with each other (and water) the weight ratio between the at least one peroxy compound and the at least one compound comprising substituted ammonium is 4:1 to 23:1.

The two- or multi-part kit system of the present invention; i.e., in particular, the solid part A and the liquid part B, can be shipped to the user where the individual parts can be stored separate from each other until being used for the preparation of the disinfectant. Both parts A and B have a long shelf life of, for example, 18 to 24 months and more, if stored in a dry and cool place, for example, not exceeding 25° C.

The present invention is also directed to a process for the preparation of a RTU disinfectant (ready-to-use disinfectant) by mixing all parts of the multi-part kit system, in particular, by mixing parts A and B of the preferred two-part kit system, and water in a ratio which ensures (i) a weight ratio between the at least one peroxy compound and the at least one compound comprising substituted ammonium of 4:1 to 23:1 and (ii) a total content of 0.07 to 1.5 wt. % of the at least one peroxy compound plus the at least one compound comprising substituted ammonium in the RTU disinfectant. Mixing of parts A and B and water results in formation of an aqueous solution.

The process of the present invention can be performed at a user's premises. It is preferred that the multi or two-part kit system of the present invention is supplied to the user in the form of separate receptacles, one of which contains the solid part A and another receptacle or, the other receptacle, contains the liquid part B.

The preparation of the RTU disinfectant can easily be performed by mixing parts A and B and water in the desired mixing ratio, for example, mixing parts A and B and water and, if necessary, diluting the aqueous mixture with water to the desired concentration.

Parts A and B may be mixed into water to obtain a RTU disinfectant with a desired concentration i.e., with a total content of the at least one peroxy compound plus the at least one compound comprising substituted ammonium of 0.07 to 1.5 wt. %. It will be appreciated that concentration may depend on the specific disinfection task to be performed.

Alternatively, parts A and B may be mixed together with a small amount of water to form a concentrate. Such concentrate may be diluted with water to form a RTU disinfectant with the desired concentration, i.e. with a total content of the at least one peroxy compound plus the at least one compound comprising substituted ammonium of 0.07 to 1.5 wt. %. Such RTU disinfectant can then be used for disinfection purposes. For example, the concentrate may be applied by proportioning equipment, which dilutes the concentrate to the required concentration. Examples of such proportioning equipment include chemical injectors and Dosatron® technologies.

Pure, deionized or distilled water may be used for mixing and dilution purposes. However, it is also possible to use tap water or well water, but in such case, it is recommended that at least one of parts A and B comprises a peroxide decomposition stabilizer, in particular, a transition metal sequestering agent.

The disinfectant prepared according to the process described hereinabove is reliably effective against a large number of germs, in particular, pathogenic germs including bacteria, viruses, spores, yeasts, fungi and algae. It may be used for different disinfecting purposes, for example, in the food, milk, brewing or beverage industry; in the medical or surgery sector; in sanitary hygiene; and in farming, for example, swine or poultry breeding, dairy farming and in laying batteries. It may be used in the disinfection of water-circulating systems, but in particular, is used by applying to surfaces for surface disinfection applications, for example, the disinfection of installations; equipment; pipework; containers; bottles; sanitary objects; work surfaces; walls; floors; ceilings or complete rooms or buildings; shoes and protective clothing of staff; transportation vehicles, especially the wheels thereof. For the purposes of surface disinfection the disinfectant may be applied by various application methods which are selected dependent on the kind of surface which is to be disinfected. Application methods include fogging (wherein fogging includes spraying and atomization), wiping, brushing, dipping and rinsing to name only the most common methods. In certain cases the application of the disinfectant may be followed by a water-rinse after the disinfectant has taken effect; however, generally this is not the case.

As already mentioned herein above, depending on the specific disinfection task to be performed, the degree of dilution of the RTU disinfectant will be selected at the lower, the upper, or between the lower and the upper end of the concentration range of 0.07 to 1.5 wt. % for the total content of the at least one peroxy compound plus the at least one compound comprising substituted ammonium.

For routine disinfection, for example, the final RTU disinfectant will typically have a total content of 0.1 to 0.6 wt. % of the at least one peroxy compound plus the at least one compound comprising substituted ammonium. Such RTU disinfectant may be applied to a surface, for example, at a rate of 300 mL/m² of surface area by conventional means, for example, using a knapsack sprayer or a pressure washer set.

For equipment disinfection, for example, the final RTU disinfectant will typically have a total content of 0.1 to 0.6 wt. % of the at least one peroxy compound plus the at least one compound comprising substituted ammonium. The equipment to be disinfected may be immersed in the RTU disinfectant and may or may not be rinsed after removal.

For disinfection tasks in a farm environment, for example, the final RTU disinfectant will typically have a total content of 0.1 to 0.6 wt. % of the at least one peroxy compound plus the at least one compound comprising substituted ammonium. Examples of typical applications in a farm environment include vehicle washing, foot- and wheel-dips and surface disinfection, in particular walls, floors and ceilings of animal houses.

For fogging disinfection, for example, the final RTU disinfectant will typically have a total content of 0.1 to 1.5 wt. % of the at least one peroxy compound plus the at least one compound comprising substituted ammonium. Such RTU disinfectant may be applied by conventional means, for example, using a thermal fogging machine at a rate of, for example, 2 to 15 mL/m³.

### EXAMPLES

Identity and vendor of commercial materials used in the examples.

Barquat® DM50 is a 50% solution of alkyl dimethyl benzyl ammonium chloride in water from Lonza.

Oxone® is pentapotassium bis(peroxymonosulfate)bis(sulfate) (86-96%), dipotassium peroxodisulfate (0-5%), and tetra[carbonato(2-)]dihydroxypentamagnesium (1-2%) from DuPont.

Mirataine® D40 is a 36-40% solution of (carboxylatomethyl)dimethyltetradecylammonium and (carboxylatomethyl)dodecyldimethylammonium in water from Rhodia.

Rovol® T500 is alcohol C16-C18 ethoxylate from The White Sea and Baltic Company Ltd.

Amphoteric® SC is a proprietary blend of amphoteric surfactant (35%) and water (65%) from Tomah Products, Inc.

Genapol® T250 is fatty alcohol polyglycol ether from Clariant.

Bardac® 22 is a 50-52% solution of N,N-Didecyl-N,N-dimethylammoniumchloride in water (26.5-30.5%) and isopropanol (19.5-24.5%) from Lonza.

Ammonyx® LO is a solution of lauramine oxide (29-32%) in water (67-70%) from Stepan.

### Example 1

### A Two-Part Kit was Made According to the Following Recipe

Two-Part Kit 1

| Part A | Weight (g) | Part B | Weight (g) |
|---|---|---|---|
| Oxone ® | 5.0 | Barquat ® DM50 | 0.94 |
| Malic acid | 0.94 | Mirataine ® D40 | 2.0 |
| Sodium sulphate | 0.503 | Rovol ® T500 | 0.3 |
| Taurine (2-amino- | 0.700 | Ethylene diamine | 0.2 |
| ethanesulfonic acid) | | tetra(methylene | |
| | | phosphonic acid) | |
| Sodium chloride | 0.063 | Water | 2.556 |
| Total | 7.206 | Total | 5.996 |

### Example 2

### A Two-Part Kit was Made According to the Following Recipe

Two-Part Kit 2

| Part A | Weight (g) | Part B | Weight (g) |
|---|---|---|---|
| Oxone ® | 5.0 | Barquat ® DM50 | 0.94 |
| Malic acid | 0.94 | Mirataine ® D40 | 2 |
| Sodium sulphate | 1.103 | Rovol ®T500 | 0.3 |
| Sulphamic acid | 0.10 | Ethylene diamine | 0.2 |
| | | tetra(methylene | |
| | | phosphonic acid) | |
| Sodium chloride | 0.063 | Water | 2.556 |
| Total | 7.206 | Total | 5.996 |

### Example 3

### A Two-Part Kit was Made According to the Following Recipe

Two-Part Kit 3

| Part A | Weight (g) | Part B | Weight (g) |
|---|---|---|---|
| Sodium percarbonate | 2.52 | Barquat ® DM50 | 0.94 |
| (Na₂CO₃•1.5 H₂O₂) | | | |
| Malic acid | 0.94 | Mirataine ® D40 | 2.0 |
| Sodium sulphate | 2.983 | Rovol ® T500 | 0.3 |
| Taurine | 0.7 | Ethylene diamine | 0.2 |
| | | tetra(methylene | |
| | | phosphonic acid) | |
| Sodium chloride | 0.063 | Water | 2.556 |
| Total | 7.206 | Total | 5.996 |

### Example 4

### A Two-Part Kit was Made According to the Following Recipe

Two-Part Kit 4

| Part A | Weight (g) | Part B | Weight (g) |
|---|---|---|---|
| Oxone ® | 5.0 | Barquat ® DM50 | 0.94 |
| Malic acid | 0.94 | Amphoteric ® SC | 2.2 |
| Sodium sulphate | 0.503 | Rovol ® T500 | 0.3 |
| Taurine | 0.7 | Ethylene diamine | 0.2 |
| | | tetra(methylene | |
| | | phosphonic acid) | |
| Sodium chloride | 0.063 | Water | 2.358 |
| Total | 7.206 | Total | 5.998 |

### Example 5

### A Two-Part Kit was Made According to the Following Recipe

Two-Part Kit 5

| Part A | Weight (g) | Part B | Weight (g) |
|---|---|---|---|
| Oxone ® | 5.0 | Barquat ® DM50 | 0.94 |
| Malic acid | 0.94 | Mirataine ® D40 | 2.0 |
| Sodium sulphate | 0.503 | Genapol ® T250 | 0.3 |
| Taurine | 0.7 | Ethylene diamine | 0.2 |
| | | tetra(methylene | |
| | | phosphonic acid) | |
| Sodium chloride | 0.063 | Water | 2.562 |
| Total | 7.206 | Total | 6.002 |

### Example 6

### A Two-Part Kit was Made According to the Following Recipe

Two-Part Kit 6

| Part A | Weight (g) | Part B | Weight (g) |
|---|---|---|---|
| Oxone ® | 5.0 | Bardac ® 22 | 0.94 |
| Malic acid | 0.94 | Mirataine ® D40 | 2.0 |
| Sodium sulphate | 0.503 | Rovol ® T500 | 0.3 |
| Taurine | 0.7 | Ethylene diamine | 0.2 |
| | | tetra(methylene | |
| | | phosphonic acid) | |
| Sodium chloride | 0.063 | Tap water | 2.556 |
| Total | 7.206 | Total | 5.996 |

### Example 7

### A Two-Part Kit was Made According to the Following Recipe

Two-Part Kit 7

| Part A | Weight (g) | Part B | Weight (g) |
|---|---|---|---|
| Oxone ® | 5.0 | Barquat ® DM50 | 0.94 |
| Malic acid | 0.94 | Ammonyx ® LO | 1.2 |
| Sodium sulphate | 0.503 | Rovol ® T500 | 0.3 |
| Taurine | 0.7 | Ethylene diamine | 0.2 |
| | | tetra(methylene | |
| | | phosphonic acid) | |
| Sodium chloride | 0.063 | Tap water | 3.36 |
| Total | 7.206 | Total | 6.0 |

Disinfectant Preparations.

Preparations were made from each of the Two-Part Kits 1-7 at about 20° C. according to the same general procedure as follows. One liter (1 L) of tap water was poured into a glass beaker, Part B was added, followed by Part A. The mixture was well stirred for 2 minutes and its appearance was visually assessed after 30 minutes and 1 hour. The appearance at 1 hour is summarized below and is the same as the 30 minute assessment.

| Disinfectant Preparation | Appearance at 1 Hour |
|---|---|
| Two-Part Kit 1 | Hazy/translucent |
| Two-Part Kit 2 | Clear |
| Two-Part Kit 3 | Clear |
| Two-Part Kit 4 | Opaque |
| Two-Part Kit 5 | Clear |
| Two-Part Kit 6 | Hazy/translucent |
| Two-Part Kit 7 | Opaque |

Even after one hour, none of the samples exhibited precipitation or sedimentation.

Disinfectant preparation stability tests.

The Disinfectant Preparations 1 and 7 were tested for their stability over a 48 hour period using the Available Oxygen Assay Method as follows. Fifty (50.0) mL of disinfectant preparation solution was accurately pipetted into a 250 mL conical flask; to this solution was added 10 mL of 10% acetic acid and 1.0 g of potassium iodide; the solution was then titrated with 0.1M sodium thiosulphate solution (Na₂S₂O₃ titre) until the test solution returned to its original color. The titration was conducted three times and the mean average result recorded as mL of Na₂S₂O₃ titre. The percent weight per volume (% w/v) of active oxygen is calculated from the Na₂S₂O₃ titre according to following formula: % w/v Active Oxygen=(0.08×Titre)/sample volume.

The disinfectant preparations for this test were made as previously described by mixing the two-part kits with 1 litre of tap water at ambient temperature (recording the temperature) and mechanically stirring for 30 minutes, prior to initial assay. A 10 second manual stir was carried out for subsequent assays at 24 and 48 hours.

Stability results for Disinfectant Preparation 1 are summarized as follows.

Disinfectant Preparation 1

| | Solution | | Avg. Na₂S₂O₃ | % w/v Active |
|---|---|---|---|---|
| Time | Temp.(° C.) | pH | titre (mL) | Oxygen |
| 0 hr | 20.0 | 2.61 | 13.69 | 0.022 |
| 24 hr | 20.3 | 2.58 | 13.21 | 0.021 |
| 48 hr | 21.6 | 2.44 | 12.33 | 0.020 |

Stability results for Disinfectant Preparation 7 are summarized as follows.

Disinfectant Preparation 7

| | Solution | | Avg. Na₂S₂O₃ | % w/v Active |
|---|---|---|---|---|
| Time | Temp.(° C.) | pH | titre (mL) | Oxygen |
| 0 hr | 19.5 | 2.68 | 13.82 | 0.022 |
| 24 hr | 20.5 | 2.62 | 13.46 | 0.022 |
| 48 hr | 21.8 | 2.55 | 13.34 | 0.021 |

The Disinfectant Preparation 3 was tested for its stability over a 48 hour period using the Hydrogen Peroxide Assay Method as follows. Twenty (20) mL of Disinfectant Preparation solution was accurately pipetted into a 250 mL conical flask containing 50 mL of distilled water, 3 mL of 20% sulphuric acid and 2 drops of ferroin indicator solution; this was then titrated with 0.1M cerium (IV) sulphate solution until the first blue end point. The titration was conducted three times and mean average result recorded as mL of cerium (IV) titre. The percent weight per volume (% w/v) of active oxygen is calculated from the Avg. Ce(IV) titre according to following formula: % w/v Active Oxygen=(0.08×titre)/sample volume.

The disinfectant preparation for this test was made as previously described by mixing the two-part kits with 1 litre of tap water at ambient temperature (recording the temperature) and mechanically stirring for 30 minutes, prior to initial assay. A 10 second manual stir was carried out for subsequent assays at 24 and 48 hours.

Stability results for Disinfectant Preparation 3 are summarized as follows.

Disinfectant Preparation 3

| | Solution | | Avg. Ce(IV) | Active Oxygen |
|---|---|---|---|---|
| Time | Temp.(° C.) | pH | titre (mL) | % w/v |
| 0 hr | 20.0 | 7.75 | 8.47 | 0.034 |
| 24 hr | 19.7 | 8.04 | 8.39 | 0.034 |
| 48 hr | 20.4 | 8.21 | 8.33 | 0.033 |

The active oxygen content is a measure of the biocidal activity. The active oxygen content of disinfectant preparations 1, 3 and 7 indicates only a slight loss of the activity level over the period tested and represents an acceptable level of stability. Many commercial, farm-based disinfectant solutions designed for use on hard surfaces are normally expected to remain viable for a full working day, typically 8-12 hours.

What is claimed is:

1. A multi-part kit system comprising:
(i) a solid part A which comprises 10 to 80 wt. % of at least one peroxy compound selected from the group consisting of KHSO₅, K₂S₂O₈, Na₂S₂O₈, magnesium monoperoxyphthalate hexahydrate, sodium percarbonate, and sodium perborate; 0.1 to 10 wt. % of at least one MCI compound wherein M is selected from the group consisting of lithium, sodium and potassium; and 1 to 20 wt. % of at least one H₂N(CH₂)ₙSO₃H compound with n=0, 1, 2 or 3, wherein the wt. % of part A ingredients is based on the total weight of solid part A; and,
(ii) a liquid part B in the form of an aqueous solution which comprises 0 to 20 wt. % of nonionic surfactant; 3.6 to 20 wt. % of amphoteric surfactant;
and 0.5 to 20 wt. % of at least one compound comprising substituted ammonium selected from the group consisting of dihydrocarbyl dimethylammonium halides, didecyl methyl-poly(oxyethyl) ammonium propionate, chlorhexidine gluconate, cetylpyridinium halide and polyhexamethylene biguanide hydrochloride, wherein at least one of the two hydrocarbyl residues comprises 8 to 18 carbon atoms, wherein halide means chloride or bromide, and wherein the wt. % of part B ingredients is based on the total weight of liquid part B.

2. The multi-part kit system of claim 1 consisting of said solid part A and said liquid part B.

3. The multi-part kit system of claim 1 or 2, wherein the solid part A is a flowable powder or takes the form of pellets or tablets.

4. The multi-part kit system of claim 1, wherein the solid part A comprises KHSO₅.

5. The multi-part kit system of claim 4, wherein the solid part A comprises no other peroxy compound than KHSO₅.

6. The multi-part kit system of claim 5, wherein the KHSO₅ is present in the form of the triple salt 2KHSO₅.KHSO₄.K₂SO₄ and the proportion of said triple salt is 20 to 98.9 wt. %, based on the total weight of solid part A.

7. The multi-part kit system of claim 1, wherein solid part A comprises H₂N(CH₂)₂SO₃H.

8. The multi-part kit system of claim 1, wherein the solid part A comprises
36 to 87 wt. % of the triple salt 2KHSO₅.KHSO₄.K₂SO₄;
0.2 to 2.6 wt. % of NaCl;
3 to 20 wt. % of H₂N(CH₂)₂SO₃H; and
5 to 50 wt. % of one or more further additives selected from the group consisting of solid water-soluble inorganic fillers, solid pH-modifiers, dyes and peroxide decomposition stabilizers;
wherein the sum of the wt. % totals 100 wt. %.

9. The multi-part kit system of claim 1, wherein the liquid part B comprises 25 to 95.9 wt. % of water.

10. The multi-part kit system of claim 1, wherein the liquid part B comprises one or more dihydrocarbyl dimethylammonium chlorides selected from the group consisting of didecyldimethylammonium chloride and benzalkonium chlorides of the formula C₆H₅CH₂(CH₃)₂(CₙH₂ₙ₊₁)N⁺Cl⁻ with n=8, 10, 12, 14, 16 or 18.

11. The multi-part kit system of claim 10, wherein the liquid part B comprises none of the following compounds: didecyl methyl-poly(oxyethyl) ammonium propionate, chlorhexidine gluconate, cetylpyridinium chloride, cetylpyridinium bromide and polyhexamethylene biguanide hydrochloride.

12. The multi-part kit system of claim 1, wherein the liquid part B comprises
57 to 84 wt. % of water;
1 to 14 wt. % of nonionic surfactant;
6 to 20 wt. % of amphoteric surfactant;
2 to 18 wt. % of at least one compound selected from the group consisting of didecyldimethylammonium chloride and benzalkonium chlorides of the formula C₆H₅CH₂(CH₃)₂(CₙH₂ₙ₊₁)N⁺Cl⁻ with n=8, 10, 12, 14, 16 or 18; and
1 to 6 wt. % of one or more further additives selected from the group consisting of MCI compounds; hard water sequestrants; corrosion inhibitors; water-soluble solvents and peroxide decomposition stabilizers;
wherein the sum of the wt. % totals 100 wt. %.

13. The multi-part kit system of claim 1, wherein the solid part A comprises:
36 to 87 wt. % of the triple salt 2KHSO₅.KHSO₄.K₂SO₄;
0.2 to 2.6 wt. % of NaCl;
3 to 20 wt. % of H₂N(CH₂)₂SO₃H; and
5 to 50 wt. % of one or more further additives selected from the group consisting of solid water-soluble inorganic fillers, solid pH-modifiers, dyes and peroxide decomposition stabilizers; and
wherein the liquid part B comprises:
57 to 84 wt. % of water;
1 to 14 wt. % of nonionic surfactant;
6 to 20 wt. % of amphoteric surfactant;
2 to 18 wt. % of at least one compound selected from the group consisting of didecyldimethylammonium chloride and benzalkonium chlorides of the formula C₆H₅CH₂(CH₃)₂(CₙH₂ₙ₊₁)N⁺Cl⁻ with n=8, 10, 12, 14, 16 or 18; and
1 to 6 wt. % of one or more further additives selected from the group consisting of MCI compounds, hard water sequestrants, corrosion inhibitors, water-soluble solvents and peroxide decomposition stabilizers;
wherein the sum of the wt. % of all ingredients in part A totals 100 wt. % and the sum of the wt. % of all ingredients in part B totals 100 wt. %.

14. The multi-part kit system of claim 1, wherein the parts A and B are such that upon mixing with each other (and water) the weight ratio between the at least one peroxy compound and the at least one compound comprising substituted ammonium is 4:1 to 23:1.

15. A process for the preparation of a RTU disinfectant comprising mixing all parts of the multi-part kit system of claim 1 and water in a ratio which ensures (i) a weight ratio between the at least one peroxy compound and the at least one compound comprising substituted ammonium in the range of 4:1 to 23:1; and (ii) a total content of 0.07 to 1.5 wt. % of the at least one peroxy compound plus the at least one compound comprising substituted ammonium based on the total weight of the RTU disinfectant.
